(19) United States
(12) Patent Application Publication
(10) Pub. No.: US 2025/0018756 A1
(43) Pub. Date: Jan. 16, 2025

(54) ARRANGEMENT FOR AMPHIBIOUS TRACKED VEHICLE

(71) Applicant: BAE Systems Hägglunds Aktiebolag, Örnsköldsvik (SE)

(72) Inventor: Tom SUNDELIN, Domsjö (SE)

(73) Assignee: BAE Systems Hägglunds Aktiebolag, Örnsköldsvik (SE)

(21) Appl. No.: 18/710,461

(22) PCT Filed: Nov. 11, 2022
(86) PCT No.: PCT/SE2022/051056

§ 371 Date: May 15, 2024

(30) Foreign Application Priority Data
Nov. 24, 2021 (SE) 2151433-6

(51) Int. Cl. B60F 3/00; B62D 55/065

(52) U.S. Cl. CPC B60F 3/0015; B62D 55/0655

(57) ABSTRACT

Disclosed is an arrangement for facilitating amphibious operation of a tracked vehicle comprising one or more vehicle bodies and at least one track assembly pair per vehicle body. Said track assembly pair is connected to the vehicle body, the track assembly pair comprising two track assemblies for driving the vehicle. Each track assembly comprises a driven endless track arranged to run over a set of wheels of the track assembly and, in connection to amphibious operation, being configured to operate under the water surface by rotating in the water providing a flow of water. The arrangement comprises gas provision device configured to, in connection to swimming operation, introduce a gaseous medium into the flow of water at the upper side of the track of the respective track assembly so as to reduce the amount of water in connection to said upper side.

### CROSS-REFERENCE TO RELATED APPLICATIONS

This application is a U.S. national stage application under 35 U.S.C. 371 of International Application No. PCT/SE2022/051056, filed Nov. 11, 2022, which claims the priority of SE Application No. 2151433-6, filed Nov. 24, 2021. The entire contents of each priority application is incorporated herein by reference.

### FIELD OF THE DISCLOSURE

The present invention relates to an arrangement for facilitating amphibious operation of a tracked vehicle. The present invention relates to a tracked vehicle with such an arrangement.

### BACKGROUND OF THE DISCLOSURE

Tracked vehicles comprising articulated tracked vehicle are in certain cases amphibious and can swim. Characteristics for swimming with articulated vehicles of today is that they swim with own displacement. They thus run deep in the water and the speed in water becomes low due to the vehicle being short. In addition, propulsion, i.e. swimming operation, with the tracks as drive source has poor efficiency.

There is thus a need to present improvements in arrangements for amphibious tracked vehicles.

### OBJECT OF THE INVENTION

An object of the present invention is to provide an arrangement for facilitating amphibious operation of a tracked vehicle, which facilitates improved swimming operation by means of the tracks of the amphibious tracked vehicle.

A further object of the present invention is to provide a tracked vehicle comprising such an arrangement.

### SUMMARY OF THE DISCLOSURE

These and other objects, which will become apparent from the following description, are achieved by an arrangement for facilitating amphibious operation of a tracked vehicle, and a tracked vehicle as set out in the appended independent claims. Preferred embodiments of the arrangement are defined in the appended dependent claims.

Specifically, an object of the invention is achieved by an arrangement for facilitating amphibious operation of a tracked vehicle. Said tracked vehicle comprises one or more vehicle bodies and at least one track assembly pair per vehicle body, said track assembly pair being connected to the vehicle body. The track assembly pair comprises two track assemblies for driving the vehicle, each track assembly comprising a drive means driven endless track arranged to run over a set of wheels of the track assembly and, in connection to amphibious operation, being configured to operate under the water surface by rotating in the water providing a flow of water so as to provide a swimming operation of the vehicle. The arrangement comprises a gas provision device configured to, in connection to swimming operation, introduce a gaseous medium into the flow of water at the upper side of the track of the respective track assembly so as to reduce the amount of water in connection to said upper side.

According to an aspect of the present disclosure, said gas provision device is configured to introduce a gaseous medium into the flow of water at the upper side of the track of the respective track assembly so as to reduce the amount of water in connection to said upper side so that a propulsion reducing force associated with said flow of water at said upper side is reduced.

By thus introducing a gaseous medium into the flow of water at the upper side of the track of the respective track assembly, the total density of the mass providing said propulsion reducing force is reduced so that the propulsion of the vehicle is improved in that the resulting overall forward force on the vehicle, created by rotation of the tracks of the track assemblies, is increased. By thus introducing a gaseous medium into the flow of water at the upper side of the track of the respective track assembly an easy and efficient way of reducing the amount of water in connection to said upper side for facilitating swimming operation the tracked is provided.

According to an aspect of the present disclosure, the arrangement for facilitating amphibious operation of a tracked vehicle is an arrangement at a tracked vehicle. According to an aspect of the present disclosure the arrangement for facilitating amphibious operation of a tracked vehicle is an arrangement of a tracked vehicle. According to an aspect of the present disclosure the arrangement for facilitating amphibious operation of a tracked vehicle is configured to be comprised in said tracked vehicle.

According to an embodiment of the arrangement, said gas provision device is configured to provide pressurized introduction of said gaseous medium such that pressurized gaseous medium is introduced into said flow of water in connection to a space over said upper side so that water in said space is reduced such that the density of the mass associated with said flow of water providing a propulsion reducing force associated with said flow of water at said upper side is reduced. By thus introducing pressurized gaseous medium into said space, reduction of the density of the mass associated with said flow of water is facilitated. According to an aspect of the present disclosure, said gas provision device may be operated in any suitable way by means of any suitable operation unit, such as a mechanical operation unit and/or an electric operation unit, e.g. electric machine/electric motor, a combustion engine, e.g. a combustion engine configured to drive the tracked vehicle.

According to an embodiment of the arrangement, said drive means configured to drive said endless track comprises a combustion engine, wherein said gas provision device is configured to utilize exhaust gas from said combustion engine for said introduction of gaseous medium into said flow of water at said upper side of said endless track. By thus utilizing exhaust gas from said combustion engine for said introduction of gaseous medium into said flow of water, efficient reduction of the density of the mass associated with said flow of water is facilitated. By thus utilizing exhaust gas from said combustion engine for said introduction of gaseous medium into said flow of water, an energy efficient arrangement may be provided in that gas exhausted during drive of the amphibious tracked vehicle is utilized. According to an aspect of the present disclosure, said gas provision device is comprised in said combustion engine. According to an aspect of the present disclosure, said combustion engine comprises said gas provision device. According to an aspect of the present disclosure, said gas provision device is configured to control said introduction of gaseous medium into the flow of water at the upper side of said endless track by means of said combustion engine. According to an aspect of the present disclosure, said gas provision device is configured to control said introduction of gaseous medium into the flow of water at the upper side of said endless track by means of said combustion engine based on rotational speed of said endless track provided by means of operation of said combustion engine. According to an aspect of the present disclosure, exhaust gas from said combustion engine is utilized for said introduction of gaseous medium into said flow of water based on rotational speed of said endless track in such a way that higher rotational speed provided by operation of said combustion engine results in higher amount of exhaust gas introduced into said flow of water relative to a lower rotational speed, lower than said higher, provided by said combustion engine. According to an aspect of the present disclosure, said combustion engine, in connection to an amphibious operation, is configured to act as said gas provision device so that introduction of said gaseous medium into said flow of water automatically is based on the rotational speed of said endless track, said rotational speed being provided by said combustion engine. According to an aspect of the present disclosure, said gas provision device may be configured to utilize exhaust gas from said combustion engine for said introduction of gaseous medium into said flow of water at said upper side of said endless track alone or in combination with introduction of other gaseous medium than said exhaust gas.

According to an embodiment of the arrangement, said gas provision device comprises a pump device and/or a compressor device configured to provide said introduction of gaseous medium into said flow of water at said upper side of said endless track. By thus utilizing a pump device and/or a compressor device for providing said introduction of gaseous medium into said flow of water, efficient reduction of the density of the mass associated with said flow of water is facilitated. By thus utilizing a pump device and/or a compressor device for providing said introduction of gaseous medium into said flow of water, control of said introduction of gaseous medium into said flow of water may be facilitated. Said pump device may comprise one or more pumps. Said compressor device may comprise one or more compressors.

According to an aspect of the present disclosure, said drive means is configured to operate said gas provision device. According to an aspect of the present disclosure, said gas provision device comprises said drive means, wherein said drive means is configured to operate one or more gas provision units for providing said introduction of gaseous medium into said flow of water. According to an aspect of the present disclosure, when said drive means configured to drive said endless track comprises a combustion engine, said combustion engine is configured to operate said gas provision device. According to an aspect of the present disclosure, when said drive means configured to drive said endless track comprises a combustion engine, said combustion engine is configured to operate a pump device and/or a compressor device of said gas provision device. According to an aspect of the present disclosure, when said drive means configured to drive said endless track comprises a combustion engine, said pump device is configured to provide said introduction of gaseous medium by means of said combustion engine providing its exhaust gas as the stand-alone pump device or as a support to a combination of different type of pump devices providing said introduction of gas medium.

According to an embodiment of the arrangement, said gaseous medium comprises air, wherein said gas provision device is configured to retain air stored within said vehicle and/or externally from an outer side portion of said vehicle configured to be above water during swimming operation of said vehicle. By thus retaining and utilizing air as at least part of the gaseous medium introduced into said space, efficient reduction of the density of the mass associated with said flow of water is facilitated in that the required amount of gaseous medium may be efficiently controlled.

According to an embodiment of the arrangement, said gas provision device is configured to control said introduction of gaseous medium into the flow of water at the upper side of said endless track based on rotational speed of said endless track. Hereby efficient control of said introduction of gaseous medium into the flow of water may be facilitated. Hereby energy efficient swimming operation of the tracked vehicle is facilitated. According to an aspect of the present disclosure, said gas provision device is configured to control said introduction of gaseous medium into the flow of water at the upper side of said endless track based on rotational speed of said endless track such that a higher amount of gaseous medium is introduced into said flow of water at a higher rotational speed than at a lower rotational speed, relatively lower than said higher rotational speed. According to an aspect of the present disclosure, said control, by means of said gas provision device, of said introduction of gaseous medium into the flow of water at the upper side of said endless track based on rotational speed of said endless track comprises controlling said introduction of gaseous medium into said flow of water based on direction of said rotational speed. According to an aspect of the present disclosure, said gas provision device is configured to control said introduction of gaseous medium into the flow of water at the upper side of said endless track based on direction of rotational speed of said endless track such that said introduction of gaseous medium into the flow of water is provided from the rear side of the tracked vehicle during a rotation of said endless track for forward drive of the tracked vehicle, and such that said introduction of gaseous medium into the flow of water is provided from the front side of the tracked vehicle during a rotation of said endless track for rearward drive of the tracked vehicle.

According to an embodiment of the arrangement, said gas provision device is configured to provide introduction of gaseous medium into the flow of water at the upper side of said endless track via one or more introduction openings in connection to said upper side. Hereby efficient introduction of gaseous medium into the flow of water for efficient reduction of the density of the mass associated with said flow of water may be facilitated.

According to an embodiment of the arrangement, said gas provision device is configured to provide introduction of gaseous medium into the flow of water at the upper side of said endless track from the rear side of the vehicle in connection to said upper side, said introduction of gaseous medium from said rear side being directed in the direction of the flow of water. Hereby efficient introduction of gaseous medium into the flow of water for efficient reduction of the density of the mass associated with said flow of water may be facilitated.

According to an embodiment, the arrangement further comprises a space provision arrangement configured to provide a space in connection to the upper side of the track of the respective track assembly so as to facilitate retention of the gaseous medium introduced by means of said gas provision device and thereby the reduction of the amount of water within said space. By thus providing such a space provision arrangement facilitating retention of the introduced gaseous medium, reduction of the amount of water within said space is efficiently facilitated.

According to an embodiment of the arrangement, said space provision arrangement comprises under structure portions of said vehicle body, each under structure portion being arranged to run over an upper side of a track of a track assembly at a distance from the upper side of the track so that said space, is provided between each under structure portion and the upper side of the track of the corresponding track assembly. By thus providing such a space provision arrangement, retention of the introduced gaseous medium is facilitated, thus further facilitating reduction of the amount of water within said space is efficiently facilitated.

According to an embodiment of the arrangement, said space provision arrangement comprises an enclosure configuration arranged so as to at least partly provide enclosure of said space. Said enclosure configuration may be arranged in connection to, e.g. connected to, said vehicle body or be integrated portions of said vehicle body. By thus providing such a space provision arrangement with an enclosure configuration, retention of the introduced gaseous medium is facilitated, thus further facilitating reduction of the amount of water within said space is efficiently facilitated.

According to an embodiment of the arrangement, said enclosure configuration comprises elongated side elements arranged at and configured to run along a respective side of the vehicle so as to provide enclosure of said space for further facilitating retention of gaseous medium introduced into said space. Said elongated side elements may be arranged in connection to, e.g. connected to, said vehicle body or be integrated portions of said vehicle body. By thus providing such a space provision arrangement with an enclosure configuration, retention of the introduced gaseous medium is facilitated, thus further facilitating reduction of the amount of water within said space is efficiently facilitated.

According to an embodiment of the arrangement, said enclosure configuration comprises front elements arranged at a front portion of the and/or rear elements arranged at a rear portion of the vehicle so as to provide further enclosure of said space for further facilitating retention of gaseous medium introduced into said space. Said front elements and/or rear elements may be arranged in connection to, e.g. connected to, said vehicle body, or be integrated portions of said vehicle body. By thus providing such a space provision arrangement with an enclosure configuration, retention of the introduced gaseous medium is facilitated, thus further facilitating reduction of the amount of water within said space is efficiently facilitated.

Specifically, an object of the invention is achieved by a tracked vehicle comprising an arrangement as set out herein.

According to an embodiment, said tracked vehicle is an articulated tracked vehicle comprising a first vehicle unit and a second vehicle unit pivotably connected to the first vehicle unit via an articulation joint, each of said vehicle units comprising a vehicle body and track assembly pair suspendedly connected to respective vehicle body.

### BRIEF DESCRIPTION OF THE FIGURES

For a better understanding of the present disclosure reference is made to the following detailed description when read in conjunction with the accompanying drawings, wherein like reference characters refer to like parts throughout the several views, and in which:

FIG. 1 schematically illustrates a side view of a tracked vehicle during amphibious operation according to prior art;

FIG. 2 schematically illustrates a side view of a tracked vehicle during amphibious operation according to an embodiment of the present disclosure;

FIG. 3 schematically illustrates a front view of the tracked vehicle in FIG. 2 during an amphibious operation according to an embodiment of the present disclosure;

FIG. 4 schematically illustrates a side view of an articulated tracked vehicle during an amphibious operation according to an embodiment of the present disclosure:

FIG. 5A schematically illustrates a front view of a portion of a tracked vehicle during an amphibious operation, said tracked vehicle being provided with an arrangement for facilitating amphibious operation of the vehicle, according to an embodiment of the present disclosure:

FIG. 5B schematically illustrates a side view of a portion of a tracked vehicle during an amphibious operation, said tracked vehicle being provided with an arrangement for facilitating amphibious operation of the vehicle, according to an embodiment of the present disclosure:

FIG. 6A schematically illustrates a front view of a portion of a tracked vehicle during an amphibious operation, said tracked vehicle being provided with an arrangement for facilitating amphibious operation of the vehicle, according to an embodiment of the present disclosure; and,

FIG. 6B schematically illustrates a side view of a portion of a tracked vehicle during an amphibious operation, said tracked vehicle being provided with an arrangement for facilitating amphibious operation of the vehicle, according to an embodiment of the present disclosure.

### DETAILED DESCRIPTION OF THE DISCLOSURE

Herein the term “amphibious operation” refers to any situation when the amphibious tracked vehicle is being operated in water, comprising swimming operation.

Herein the term “land operation” refers to any situation when the amphibious tracked vehicle is on land and not being in connection to an amphibious operation. The term “land operation” refers to the amphibious tracked vehicle being on the ground and driving on the ground or being prepared for driving on the ground.

Herein the term “swimming operation” refers to any situation when the amphibious tracked vehicle is being propelled in water by means of rotation of the tracks of the track assemblies of the tracked vehicle.

Herein the term “upper side of the track of track assembly” refers to the side of the portion of the track facing upwards and the term “underside of the track of a track assembly” refers to the opposite side, i.e. the side of the portion of the track facing downwards. During land operation the term “underside of the track of a track assembly” refers to the side facing the ground and engaging with the ground. During drive of the vehicle by means of the tracks of the track assembly, i.e. during rotation of the tracks of the track assembly, the upper side and lower side of the track changes based on the rotation of the track. The tracked vehicle has a longitudinal extension ending with a front side and an opposite rear side. The tracked vehicle further has a transversal extension with track assemblies on the respective side. According to an aspect, the side of the portion of the track facing upwards is facing upwardly in a direction essentially orthogonal to the longitudinal and transversal extension of the tracked vehicle, when the vehicle is in an essentially horizontal position.

The tracked vehicle according to the present disclosure may be any tracked vehicle suitable for amphibious operation. The tracked vehicle according to the present disclosure may thus be any suitable amphibious tracked vehicle having left and right track assemblies wherein under structure portions are running over, and at a certain distance from, the upper side of the of the track of the respective track assembly. The tracked vehicle according to the present disclosure may be a single tracked vehicle. The tracked vehicle according to the present disclosure may be an articulated tracked vehicle comprising a first vehicle unit and a second vehicle unit pivotably connected to the first vehicle unit via an articulation joint. The tracked vehicle according to the present disclosure may be operated by any suitable drive means such as an internal combustion engine and or/or an electric motor. One or more tracks of the track assemblies of the tracked vehicle may be rotated during swimming operation.

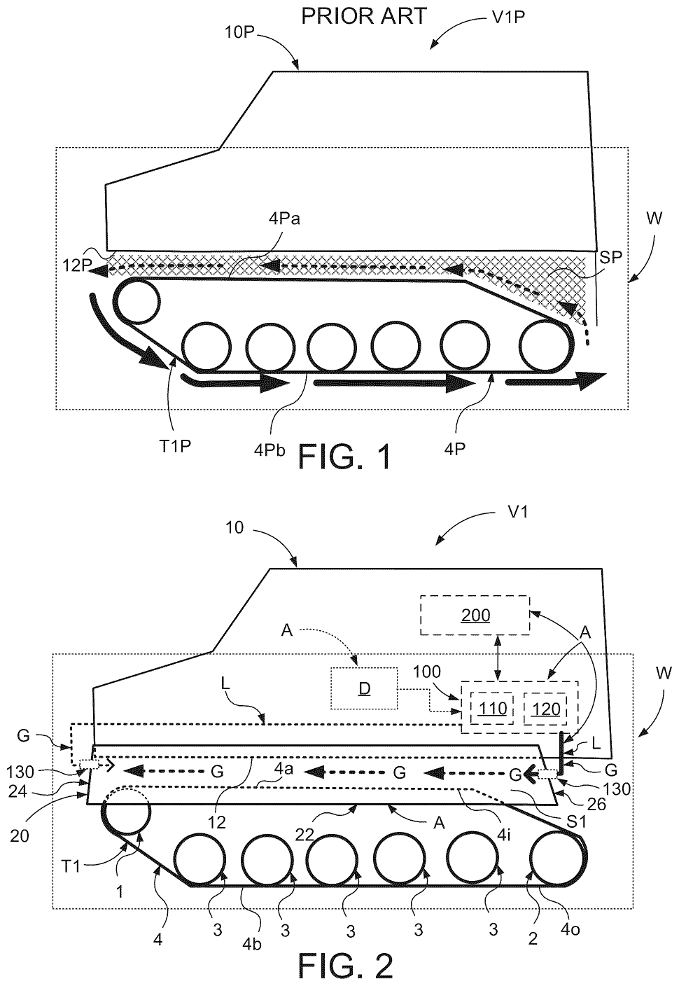

FIG. 1 schematically illustrates a side view of a tracked vehicle VIP during an amphibious operation according to prior art. The vehicle VIP is viewed from the left side. The vehicle VIP is swimming in water W.

The tracked vehicle VIP comprises a track assembly pair. The track assembly pair comprises opposite track assemblies for driving the vehicle, a left track assembly TIP, shown in FIG. 1, and a right track assembly.

The tracked vehicle VIP comprises a vehicle body 10P. The track assembly pair is suspendedly connected to the vehicle body 10P.

Each track assembly comprises an endless track 4P arranged to run over a set of wheels of the track assembly TIP.

The vehicle body 10P comprises under structure portions, a left under structure portion 12P, shown in FIG. 1, running over an upper side 4Pa of a track 4P of a track assembly at a distance from the upper side of the track. A space SP is hereby provided between each under structure portion 12P and the upper side 4Pa of the track 4P of the corresponding track assembly.

During swimming operation by means of rotating the tracks of the respective track assembly, water will be transported around the tracks 4P as illustrated in FIG. 1. Thus, during swimming operation by means of rotation of the tracks 4P water will flow in the backward direction on the underside 4Pb of the track 4P, illustrated by the solid arrows, and water will flow in the forward direction on the upper side 4Pa of the track 4P within said space SP, illustrated by the dotted arrows. The water forced by the rotating track 4P in the backward direction on the underside 4Pb of the track is providing a forward force on the vehicle VIP. The water forced by the rotating track 4P in the forward direction on the upper side 4Pa of the track 4P is providing a backward force on the vehicle VIP, reducing the efficiency of the swimming operation of the vehicle VIP.

FIG. 2 schematically illustrates a side view of a tracked vehicle V1 during an amphibious operation according to an embodiment of the present disclosure. The vehicle V1 is viewed from the left side. The vehicle V1 is swimming in water W.

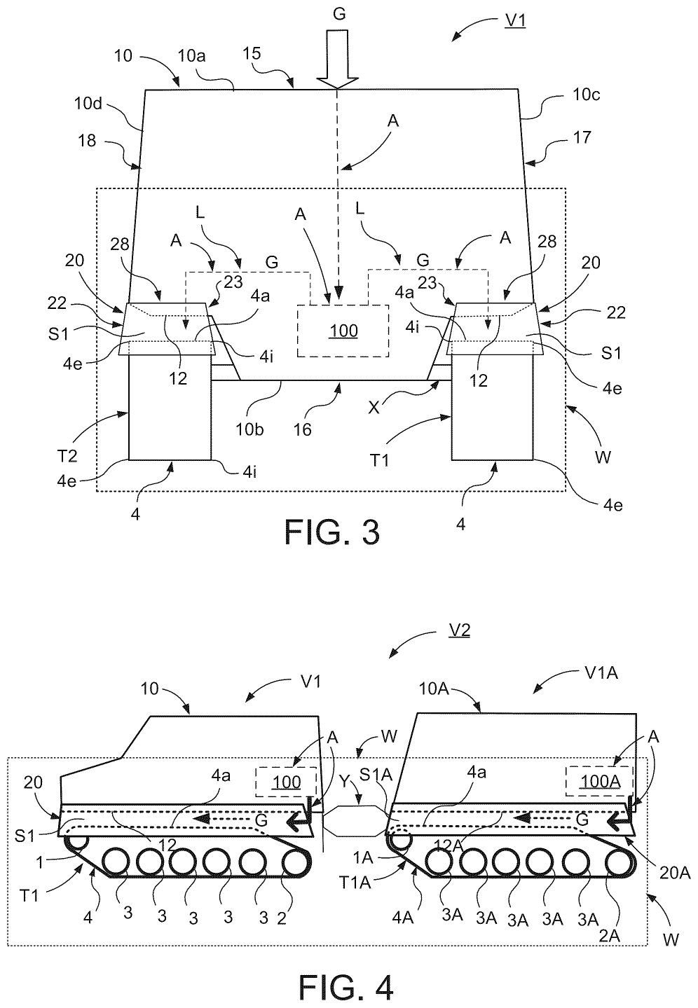

FIG. 3 schematically illustrates a front view of the tracked vehicle V1 in FIG. 2 during an amphibious operation according to an embodiment of the present disclosure. In FIG. 3 the tracked vehicle V1 is swimming in water W as in FIG. 2.

The tracked vehicle V1 comprises a track assembly pair T1, T2 as seen in FIG. 3. The track assembly pair comprises opposite track assemblies T1, T2 for driving the vehicle, a left track assembly T1, and a right track assembly T2. The left track assembly T1 is shown in FIG. 2.

The tracked vehicle V1 comprises a vehicle body 10. The track assembly pair T1, T2 is suspendedly connected to the vehicle body 10.

The respective track assembly, in FIG. 2 illustrated with the left track assembly T1, comprises two end wheels 1, 2 in the form of a front wheel 1 and a rear wheel 2, and further a plurality of road wheels 3 there between. The front wheel 1 is according to the present disclosure a drive wheel 1 and the rear wheel 2 is according to the present disclosure a tension wheel 2. The respective track assembly, in FIG. 2 illustrated with the left track assembly T1, further comprises a plurality of road wheels 3.

The respective track assembly, in FIG. 2 illustrated with the left track assembly T1, further comprises an endless track 4. Said endless track 4 is configured to be disposed around said end wheels 1, 2 and plurality of road wheels 3. The endless track 4 is thus configured to run around the drive wheel 1, tension wheel 2 and plurality of road wheels 3. Each track assembly T1, T2 thus comprises an endless track 4 arranged to run over a set of wheels of the track assembly T1, T2.

The endless track 4 is a propulsion track 4 running around said wheels 1, 2, 3 for driving the vehicle V1. The endless track 4 has an inner side 4i with an inner surface which at least partly is in contact with the wheels 1, 2, 3 when the endless track is running around the wheels 1, 2, 3. The endless track 4 has an outer side 40 with an outer surface which, during swimming operation, will be in contact with water and move the water when the endless track is running around the wheels 1, 2, 3. When the endless track is running around the wheels 1, 2, 3 a portion of the outer side 40 will be faced upwardly and thus be an upper side 4a and an opposite portion of the outer side will face downwardly and thus be an underside 4b. Said track 4 has an external side portion 4e facing outwardly in a direction parallel to the axial direction of the wheels of the vehicle V1 and thus in the transversal direction of the vehicle away from the vehicle, and an opposite internal side portion 4i facing in the opposite direction, i.e. facing inwardly in a direction parallel to the axial direction of the wheels of the vehicle V1 and thus in the transversal direction of the vehicle towards the opposite track assembly of the track assembly pair of the vehicle V1.

The drive wheel 1 is configured to be operated by any suitable drive means D such as an internal combustion engine and or/or an electric motor. The drive means D is schematically illustrated in FIG. 2. The drive wheel 1 is configured to be rotated by the drive means D for rotating the endless track for driving the vehicle. The drive wheel 1 is according to an aspect of the disclosure configured to be operably connected to the drive means via a drive axle X as illustrated in FIG. 3, the drive means not being shown in FIG. 3.

Further the vehicle V1 comprises a vehicle body 10. According to an aspect of the present disclosure, the vehicle body 10 includes the chassis of the vehicle V1. According to an aspect of the present disclosure, the vehicle body 10 may include the bodywork.

The vehicle body 10 comprises under structure portions 12, see FIGS. 2 and 3, configured to run over an upper side 4a of a track 4 of a track assembly at a distance from the upper side 4a of the track 4, providing a space S1.

As shown in FIG. 3, the vehicle body 10 comprises a left under structure portion 12 running over an upper side 4a of a track 4 of the left track assembly T1 at a distance from the upper side 4a of the track 4 providing a space S1, i.e. a left space S1. As shown in FIG. 3, the vehicle body 10 comprises a right under structure portion 12 running over an upper side 4a of a track 4 of the right track assembly T2 at a distance from the upper side 4a of the track 4 providing a space, i.e. a right space S1. A space S1 is hereby provided between each under structure portion 12 and the upper side 4a of the track 4 of the corresponding track assembly T1, T2.

As shown in FIG. 3, the vehicle body 10 comprises a roof portion 15. The vehicle body 10 comprises an upper side 10a. The upper side 10a constitutes the upper side of the roof portion 15 of the vehicle body 10.

As shown in FIG. 3, the vehicle body 10 comprises a central under structure 16 centrally arranged between the left track assembly T1 and right track assembly T2. The vehicle body 10 comprises a central underside 10b. The central underside 10b constitutes the underside of the central under structure 16. The underside 10b of the central under structure 16 is according to an aspect of the present disclosure configured to be at a level below the upper side 4a of the track 4 of the respective track assembly T1, T2. The underside 10b of the central under structure 16 is according to an aspect of the present disclosure configured to be at a certain height above the ground, providing a desired ground clearance. The central under structure 16 is according to an aspect of the present disclosure configured to be suspendedly connected to the track assembly pair T1, T2. The central under structure 16 may according to an aspect of the present disclosure be configured to house drive means of the vehicle V1.

As shown in FIG. 3, the vehicle body 10 comprises a left wall portion 17. The vehicle body 10 comprises a left side 10c. The left side 10c constitutes the external side of the left wall portion 17 of the vehicle body 10.

The transversal extension of the left wall portion 17 essentially corresponds to the transversal extension of the outer side of the left track assembly T1. The lower portion of the left wall portion 17 is arranged in connection to the left under structure portion 12.

As shown in FIG. 3, the vehicle body 10 comprises a right wall portion 18 opposite to the left wall portion 17. The vehicle body 10 comprises a right side 10d. The right side 10c constitutes the external side of the right wall portion 18 of the vehicle body 10.

The transversal extension of the right wall portion 18 essentially corresponds to the transversal extension of the outer side of the right track assembly T1. The lower portion of the right wall portion 18 is arranged in connection to the right under structure portion 12.

Thus, the width of the vehicle body 10 essentially corresponds to the width of the track assembly pair T1, T2. Hereby the under structure portions 12 run over the respective track assembly T1, T2.

The tracked vehicle V1 comprises according to an aspect of the present disclosure a suspension system. The suspension system may be any suitable suspension system. The suspension system comprises according to an aspect of the present disclosure a suspension device for the respective track assembly. The respective track assembly of the tracked vehicle V1 is thus arranged to be supported by the vehicle body 10 by means of said suspension device. The road wheels 3 of the respective track assembly of the tracked vehicle V1 is according to an aspect of the present disclosure arranged to be supported by the vehicle body 10 by means of said suspension device.

Said track assemblies T1, T2 may be suspendedly arranged to said vehicle body 10 via said road wheels 3 by means of the suspension system.

The amphibious tracked vehicle V1 comprises an arrangement A for facilitating swimming operation of the tracked vehicle.

The arrangement A comprises a gas provision device 100 configured to, in connection to swimming operation, introduce a gaseous medium G into the flow of water at the upper side 4a of the track 4 of the respective track assembly T1, T2 so as to reduce the amount of water in connection to said upper side.

According to an aspect of the present disclosure, said gas provision device 100 is configured to introduce a gaseous G medium into the flow of water at the upper side 4a of the track of the respective track assembly so as to reduce the amount of water in connection to said upper side 4a so that a propulsion reducing force associated with said flow of water at said upper side 4a is reduced.

Said gas provision device 100 is configured to provide pressurized introduction of said gaseous medium G such that pressurized gaseous medium G is introduced into said flow of water in connection to a space S1 over said upper side 4a so that water in said space is reduced such that the density of the mass associated with said flow of water providing said propulsion reducing force is reduced.

According to an aspect of the present disclosure, said gas provision device 100 comprises a pump device 110. Said pump device may comprise one or more pumps.

According to an aspect of the present disclosure, said gas provision device 100 comprises a compressor device 120 configured to provide said introduction of gaseous medium G into said flow of water at said upper side 4a of said endless track 4. Said compressor device 120 may comprise one or more compressors.

According to an aspect of the present disclosure, said drive means D is configured to operate said gas provision device 100. According to an aspect of the present disclosure, said drive means D is configured to operate said gas provision device 100 for providing said introduction of gaseous medium into said space S1 with said flow of water at said upper side 4a of said endless track 4.

According to an aspect of the present disclosure, said gas provision device 100 comprises said drive means D. According to an aspect of the present disclosure, said gas provision device 100 is configured to operate one or more gas provision units by means of said drive means D for providing said introduction of gaseous medium into said space S1 with said flow of water at said upper side 4a of said endless track 4. Said one or more gas provision units may comprise said pump device 110 and/or said compressor device 120.

According to an aspect of the present disclosure, said arrangement A for facilitating amphibious operation comprises said drive means D.

According to an aspect of the present disclosure, when said drive means D configured to drive said endless track comprises a combustion engine, said combustion engine is configured to operate said gas provision device 100. According to an aspect of the present disclosure, when said combustion engine is configured to operate said gas provision device 100, said combustion engine is configured to operate a pump device 110 and/or a compressor device 120 of said gas provision device 100.

According to an aspect of the present disclosure, when said drive means D configured to drive said endless track comprises one or more electric motors, one or more of said one or more electric motors are configured to operate said gas provision device 100. According to an aspect of the present disclosure, when said one or more electric motors are configured to operate said gas provision device 100, said one or more electric motors are configured to operate a pump device 110 and/or a compressor device 120 of said gas provision device 100.

According to an aspect of the present disclosure, when said drive means D configured to drive said endless track comprises a combustion engine and one or more electric motors, said combustion engine and/or one or more of said one or more electric motors are configured to operate said gas provision device 100, e.g. a pump device 110 and/or a compressor device 120 of said gas provision device 100.

According to an aspect of the present disclosure, said drive means D is configured to operate a pump device 110 and/or a compressor device 120 of said gas provision device 100.

According to an aspect of the present disclosure, when said drive means D configured to drive said endless track 4 comprises a combustion engine, said pump device 110 is configured to provide said introduction of gaseous medium by means of said combustion engine providing its exhaust gas as the stand-alone pump device 110 or as a support to a combination of different type of pump devices providing said introduction of gaseous medium G into said space S1.

According to an aspect of the present disclosure, when said drive means D configured to drive said endless track 4 comprises a combustion engine, said gas provision device 100 is configured to utilize exhaust gas from said combustion engine for said introduction of gaseous medium into said space S1 with said flow of water at said upper side 4 of said endless track 4.

According to an aspect of the present disclosure, said gas provision device 100 is configured to provide introduction of exhaust gas into said space S1 with said flow of water at said upper side 4 of said endless track 4 so as to facilitate efficient reduction of the density of the mass associated with said flow of water.

By thus utilizing exhaust gas from said combustion engine for said introduction of gaseous medium G into said flow of water, an energy efficient arrangement may be provided in that gas exhausted during drive of the amphibious tracked vehicle is utilized.

According to an aspect of the present disclosure, said gas provision device 100 is comprised in said combustion engine. According to an aspect of the present disclosure, said combustion engine comprises said gas provision device 100.

According to an aspect of the present disclosure, said gas provision device 100 is configured to control said introduction of gaseous medium G into the flow of water at the upper side 4a of said endless track 4 by means of said combustion engine. According to an aspect of the present disclosure, said gas provision device 100 is configured to control said introduction of gaseous medium G into the flow of water at the upper side 4a of said endless track 4 by means of said combustion engine based on rotational speed of said endless track 4 provided by means of operation of said combustion engine.

According to an aspect of the present disclosure, exhaust gas from said combustion engine is utilized for said introduction of gaseous medium G into said flow of water based on rotational speed of said endless track 4 in such a way that higher rotational speed provided by operation of said combustion engine results in higher amount of exhaust gas introduced into said flow of water relative to a lower rotational speed, lower than said higher rotational speed, provided by said combustion engine.

According to an aspect of the present disclosure, said combustion engine, in connection to an amphibious operation, is configure to act as said gas provision device 100 so that introduction of said gaseous medium G into said flow of water automatically is based on the rotational speed of said endless track 4, said rotational speed being provided by said combustion engine.

According to an aspect of the present disclosure, said gas provision device 100 may be configured to utilize exhaust gas from said combustion engine for said introduction of gaseous medium G into said flow of water at said upper side 4a of said endless track 4 alone or in combination with introduction of other gaseous medium G than said exhaust gas.

According to an aspect of the present disclosure, said gaseous medium G comprises air.

According to an aspect of the present disclosure, said gas provision device 100 is configured to retain air stored within said vehicle V1. According to an aspect of the present disclosure, said gas provision device 100 is configured to provide introduction of air stored within said vehicle into said space S1 with said flow of water at said upper side 4 of said endless track 4 so as to facilitate efficient reduction of the density of the mass associated with said flow of water.

According to an aspect of the present disclosure, said gas provision device 100 is configured to retain air externally from an outer side portion of said vehicle V1 configured to be above water during swimming operation of said vehicle V1, see e.g. FIG. 3. According to an aspect of the present disclosure, said gas provision device 100 is configured to retain air externally from an outer side portion of said vehicle V1 and introduce said air into said space S1 with said flow of water at said upper side 4 of said endless track 4 so as to facilitate efficient reduction of the density of the mass associated with said flow of water.

According to an aspect of the present disclosure, said gas provision device 100 is configured to provide introduction of air into said space S1 with said flow of water at said upper side 4 of said endless track 4 so as to facilitate efficient reduction of the density of the mass associated with said flow of water.

By thus retaining and utilizing air as at least part of the gaseous medium introduced into said space, efficient reduction of the density of the mass associated with said flow of water is facilitated in that the required amount of gaseous medium may be efficiently controlled.

According to an aspect of the present disclosure, said gas provision device 100 is configured to provide introduction of gaseous medium into the flow of water at the upper side 4a of said endless track 4 via one or more introduction openings in connection to said upper side 4a.

According to an aspect of the present disclosure, said arrangement A for facilitating amphibious operation of a tracked vehicle V1 comprises a gas valve arrangement 130 for controlling introduction of gaseous medium G into the flow of water at the upper side 4a of the track 4. According to an aspect of the present disclosure, said gas valve arrangement 130 is comprised in and/or operably connected to said gas provision device 100. According to an aspect of the present disclosure, said gas provision device 100 comprises a gas valve arrangement 130 for controlling introduction of gaseous medium G into the flow of water at the upper side 4a of the track 4.

According to an aspect of the present disclosure, said gas valve arrangement 130 is configured to control introduction of gaseous medium G into said space S1 with the flow of water at the upper side 4a of the track 4.

According to an aspect of the present disclosure, said gas valve arrangement 130 is operable between a closed position in which said gaseous medium is prevented from being introduced into said space S1 and an open position in which said gaseous medium is allowed to be introduced into said space S1. According to an aspect of the present disclosure, said gas valve arrangement 130 may be operable between different degrees of openness between said closed position and said open position, said open position being a fully open position. According to an aspect of the present disclosure, said gas valve arrangement 130 may be configured to provide a closed position, a fully open position and open positions with different degree of openness. According to an aspect of the present disclosure, said gas valve arrangement 130, when open or partly open for supplying gaseous medium into said space S1, is configured to prevent flow in the opposite direction so as to prevent flow of water in said opposite direction. According to an aspect of the present disclosure, said gas valve arrangement 130 comprises one or more check valves, non-return valves or the like.

According to an aspect of the present disclosure, said gas valve arrangement 130 is configured, in said open position and where applicable said positions with certain degree of openness, to provide said one or more introduction openings in connection to said upper side.

According to an aspect of the present disclosure, said gas valve arrangement 130 comprises one or more valve members for said control of introduction of gaseous medium G into the flow of water at the upper side 4a of the track 4. According to an aspect of the present disclosure, a respective introduction opening of said one or more introduction openings is associated with a corresponding valve member of said one or more valve members of said gas valve arrangement 130.

According to an aspect of the present disclosure, said gas valve arrangement 130 is operably connected to a gas line arrangement L through which said gaseous medium is configured to be transported by means of said gas provision device 100. Said gas line arrangement is comprised in or operably connected to said gas provision device 100.

According to an aspect of the present disclosure, said gas line arrangement L comprises one or more gas lines for transporting said gaseous medium for introduction of said gaseous medium G into the flow of water at the upper side 4a of the track 4. According to an aspect of the present disclosure, a respective gas line of said one or more gas lines is associated with a corresponding valve member of said one or more valve members of said gas valve arrangement 130. Gas line refers to any line suitable gas transportation means for transporting a gaseous medium, e.g. a pressurised gaseous medium. Gas line may also be denoted gas tube, gas pipe, or the like.

According to an aspect of the present disclosure, schematically illustrated in FIG. 2, said gas provision device 100 is configured to provide introduction of gaseous medium into the flow of water at the upper side 4a of said endless track 4 from the rear side of the vehicle V1 in connection to said upper side 4a. According to an aspect of the present disclosure, said introduction of gaseous medium from said rear side is configured to be directed in the direction of the flow of water in said space S1 at the upper side 4a. According to an aspect of the present disclosure, schematically illustrated in FIG. 2, said gas provision device 100 is configured to provide introduction of gaseous medium into the space S1 at the upper side 4a of said endless track 4 from the rear side of the vehicle V1 in connection to said upper side 4a via said gas valve arrangement 130.

According to an aspect of the present disclosure, schematically illustrated in FIG. 2, said gas provision device 100 is configured to provide introduction of gaseous medium into the flow of water at the upper side 4a of said endless track 4 from the rear side of the vehicle V1 in connection to said upper side 4a during forward drive of the tracked vehicle V1 so that said gaseous medium G is introduced in the direction of the flow of water in said space S1 at the upper side 4a. According to an aspect of the present disclosure, schematically illustrated in FIG. 2, said gas provision device 100 may be configured to provide introduction of gaseous medium into the flow of water at the upper side 4a of said endless track 4 from the front side of the vehicle V1 in connection to said upper side 4a during rearward drive of the tracked vehicle V1 so that said gaseous medium G is introduced in the direction of the flow of water in said space S1 at the upper side 4a.

According to an aspect of the present disclosure, said gas provision device 100 is configured to control said introduction of gaseous medium into the flow of water at the upper side 4a of said endless track 4 based on direction of rotational speed of said endless track 4.

According to an aspect of the present disclosure, said gas provision device 100 is configured to control said introduction of gaseous medium into the flow of water at the upper side 4a of said endless track 4 based on rotational direction of said endless track 4.

According to an aspect of the present disclosure, said gas provision device 100 is configured to control said introduction of gaseous medium into the flow of water at the upper side 4a of said endless track 4 based on direction of rotational speed of said endless track 4 such that said introduction of gaseous medium G into the flow of water is provided from the rear side of the tracked vehicle V1 during a rotation of said endless track 4 for forward drive of the tracked vehicle V1, and such that said introduction of gaseous medium into the flow of water is provided from the front side of the tracked vehicle V1 during a rotation of said endless track for rearward drive of the tracked vehicle V1.

According to an aspect of the present disclosure, said arrangement A comprises a space provision arrangement 12, 20 configured to provide said space S1 in connection to the upper side 4a of the track 4 of the respective track assembly T1, T2. Said space provision arrangement 12, 20 is configured to be arranged so as to facilitate retention of the gaseous medium G introduced by means of said gas provision device 100 and thereby the reduction of the amount of water within said space S1.

According to an aspect of the present disclosure, said space provision arrangement 12, 20 comprises said under structure portions 12 of said vehicle body 10. Each under structure portion 12 is arranged to run over an upper side 4a of a track 4 of a track assembly T1, T2 at a distance from the upper side 4a of the track 4 so that said space S1 is provided between each under structure portion 12 and the upper side 4a of the track 4 of the corresponding track assembly T1, T2.

According to an aspect of the present disclosure, said space provision arrangement 12, 20 comprises an enclosure configuration 20 arranged in connection to said vehicle body 10 so as to at least partly provide enclosure of said space S1.

According to an aspect of the present disclosure, said enclosure configuration 20 comprises elongated side elements 22, 23 arranged at and configured to run along a respective side of the vehicle so as to provide enclosure of said space S1 for further facilitating retention of gaseous medium G introduced into said space S1. According to an aspect of the present disclosure, said elongated side elements 22, 23 are arranged at and configured to run along the respective track assembly T1, T2. According to an aspect of the present disclosure, said elongated side elements 22, 23 are arranged at and configured to run along a respective side of the vehicle in connection to the respective track assembly T1, T2.

According to an aspect of the present disclosure, said elongated side elements 22, 23 comprises external side elements 22 configured to run in connection to and externally relative to said under structure portion and said external side 4e of said upper portion 4a of said track 4. According to an aspect of the present disclosure, said elongated side elements 22, 23 may comprise internal side elements 23 configured to run in connection to and internally relative to said under structure portion and said internal side 4i of said upper portion 4a of said track 4. According to an aspect of the present disclosure, said internal side elements 23 are arranged to run essentially parallel to said external side elements 22 along said vehicle V1.

According to an aspect of the present disclosure, said elongated side elements 22, 23 are configured to run in connection to said vehicle body 10. According to an aspect of the present disclosure, said elongated side elements 22, 23 are connected to said vehicle body 10 and configured to run in connection to the respective track assembly T1, T2 so as to provide enclosure of said space S1. According to an aspect of the present disclosure, said elongated side elements 22, 23 are an integrated portion of said vehicle body, arranged at and configured to run along a respective side of the vehicle so as to provide enclosure of said space S1. According to an aspect of the present disclosure, said external side elements 22 and/or said internal side elements 23 are an integrated portion of said vehicle body, arranged at and configured to run along a respective side of the vehicle in connection to the respective track assembly T1, T2 so as to provide enclosure of said space S1.

Said elongated side elements 22, 23 may have any suitable configuration and design. According to an aspect of the present disclosure, said elongated side elements 22, 23 have a plate shaped or wall shaped configuration arranged at and configured to run along a respective side of the vehicle.

According to an aspect of the present disclosure, said enclosure configuration 20 comprises front elements 24 arranged at a front portion of the vehicle V1 so as to provide further enclosure of said space for further facilitating retention of gaseous medium introduced into said space S1. According to an aspect of the present disclosure, said front elements 24 are arranged in connection to the front portion of the respective track assembly T1, T2, the front portion referring to the front of the vehicle.

According to an aspect of the present disclosure, said front elements 24 are arranged in connection to said vehicle body 10. According to an aspect of the present disclosure, said front elements 24 are connected to front portions of said vehicle body 10 so as to provide enclosure of said space S1. According to an aspect of the present disclosure, said front elements 24 are an integrated portion of a front portion said vehicle body 10 so as to provide enclosure of said space S1.

Said front elements 24 may have any suitable configuration and design. According to an aspect of the present disclosure, said front elements 24 have a plate shaped or wall shaped configuration arranged at a front portion of said vehicle at the respective track assembly T1, T2.

According to an aspect of the present disclosure, said enclosure configuration 20 comprises rear elements 26 arranged at a rear portion of the vehicle V1 so as to provide further enclosure of said space for further facilitating retention of gaseous medium introduced into said space S1. According to an aspect of the present disclosure, said rear elements 26 are arranged in connection to the rear portion of the respective track assembly T1, T2, the rear portion referring to the rear of the vehicle.

According to an aspect of the present disclosure, said rear elements 26 are arranged in connection to said vehicle body 10. According to an aspect of the present disclosure, said rear elements 26 are connected to rear portions of said vehicle body 10 so as to provide enclosure of said space S1. According to an aspect of the present disclosure, said rear elements 26 are an integrated portion of a rear portion said vehicle body 10 so as to provide enclosure of said space S1.

Said rear elements 26 may have any suitable configuration and design. According to an aspect of the present disclosure, said rear elements 26 have a plate shaped or wall shaped configuration arranged at a rear portion of said vehicle at the respective track assembly T1, T2.

According to an aspect of the present disclosure, said enclosure configuration 20 may comprise elongated roof elements 28 configured to run in connection to the respective track assembly T1, T2 above said upper side 4a so as to provide enclosure of said space S1. Said elongated roof elements 28 are according to an embodiment arranged in connection to said under structure portion 12 of the vehicle body. Said elongated roof elements 28 are according to an embodiment an integrated part of said under structure portion 12 of the vehicle body.

Said enclosure configuration 20 may be arranged to provide a skirt configuration in connection to said upper side 4a of said track 4 of the respective track assembly T1, T2 of the amphibious tracked vehicle V1 so as to provide enclosure of said space S1.

One or more of said elongated side element 22, 23, said front elements 24 and rear elements 26 of the enclosure configuration 20 for the respective side of the vehicle V1 may be attached to the under structure portion 12 for the respective side of the vehicle so as to provide said space provision arrangement for providing said space S1 and enclosure for facilitating retention of gaseous medium introduced into said space S1. Said under structure portion 12 for the respective side of the vehicle V1 provides a sealing of said space S1.

According to an aspect of the present disclosure, said space provision arrangement 12, 20 comprises one or more of said one or more introduction openings via which openings said gas provision device 100 is configured to provide introduction of gaseous medium into the flow of water at the upper side 4a of said endless track 4.

According to an aspect of the present disclosure, said under structure portions 12 comprises one or more of said one or more introduction openings via which openings said gas provision device 100 is configured to provide introduction of gaseous medium into the flow of water at the upper side 4a of said endless track 4.

According to an aspect of the present disclosure, said enclosure configuration 20 comprises one or more of said one or more introduction openings via which openings said gas provision device 100 is configured to provide introduction of gaseous medium into the flow of water at the upper side 4a of said endless track 4.

According to an aspect of the present disclosure, one or more of said elongated side elements 22, 23, said front elements 24 and rear elements 26 of said enclosure configuration 20 comprises one or more of said one or more introduction openings via which openings said gas provision device 100 is configured to provide introduction of gaseous medium into the flow of water at the upper side 4a of said endless track 4.

According to an aspect of the present disclosure, one or more of said one or more valve members of said gas valve arrangement 130, via which said gas provision device 100 is configured to provide introduction of gaseous medium into the flow of water at the upper side 4a of said endless track 4, are arranged in connection to said space provision arrangement 12, 20.

According to an aspect of the present disclosure, one or more of said one or more valve members of said gas valve arrangement 130 are arranged in connection to said under structure portions 12.

According to an aspect of the present disclosure, one or more of said one or more valve members of said gas valve arrangement 130 are arranged in connection to said enclosure configuration 20. According to an aspect of the present disclosure, one or more of said one or more valve members of said gas valve arrangement 130 are connected to said enclosure configuration 20.

According to an aspect of the present disclosure, one or more of said one or more valve members of said gas valve arrangement 130 are arranged in connection to one or more of said elongated side elements 22, 23, said front elements 24, rear elements 26 and, where applicable, said elongated roof element 28 of said enclosure configuration 20.

Said enclosure configuration 20 may comprise existing parts of the vehicle, i.e. existing parts of the vehicle body and/or existing parts attached to said vehicle body and configured such that certain enclosure of said space is facilitated.

The main purpose of the present disclosure is to facilitate amphibious operation of a tracked vehicle such that the swimming operation and hence the movement of the tracked vehicle in water is facilitated such that the tracked vehicle may move at a higher speed during swimming operation. Above, with reference to e.g. FIG. 2, an arrangement A for facilitating amphibious operation of a tracked vehicle V1 is disclosed, said arrangement A comprising an enclosure configuration 20 for at least partly providing enclosure of the space S1 over said upper side 4a of the endless track 4 so that reduction of water in said space is facilitated such that the density of the mass associated with said flow of water providing said propulsion reducing force is reduced in connection to introduction of gaseous medium G into said space S1 by means of said gas provision device 100. Such enclosure configuration 20 or similar enclosure configuration 20 is also illustrated in FIGS. 3, 4, 5A-5B and 6A-6B described below.

The gas provision device 100 of the arrangement A for facilitating amphibious operation of a tracked vehicle may, according to an aspect of the present disclosure, be utilized without such an enclosure configuration, and still obtain an improved swimming ability of the tracked vehicle during amphibious operation.

The gas provision device 100 of the arrangement A for facilitating amphibious operation of a tracked vehicle may, according to an aspect of the present disclosure, be integrated into e.g. a tracked vehicle VIP illustrated in FIG. 1. The gas provision device 100 applied to such a tracked vehicle, lacking or only having portions of such an enclosure configuration device 20, may be a gas provision device as described with reference to any of FIGS. 2, 3, 4, 5A-5B and 6A-6B. Such a tracked vehicle may comprise a drive means for driving said endless track, where said drive means comprises a combustion engine, wherein said gas provision device 100 is configured to utilize exhaust gas from said combustion engine for said introduction of gaseous medium into said flow of water at said upper side 4a of said endless track 4, facilitating efficient swimming operation. The arrangement for facilitating amphibious operation of such a tracked vehicle may comprise a gas provision device 100 which is configured to control said introduction of gaseous medium G into the flow of water at the upper side 4a of said endless track 4 based on rotational speed of said endless track 4.

The gas provision device 100 of the arrangement A for facilitating amphibious operation of a tracked vehicle may, according to an aspect of the present disclosure, be utilized without such an enclosure configuration e.g. according to FIG. 2, but where under structure portions 12 of said vehicle body 10 arranged to run over an upper side 4a of a track 4 of a track assembly T1 at a distance from the upper side 4a of the track 4 so that said space is provided between each under structure portion 4 and the upper side 4a of the track 4 of the corresponding track assembly.

Thus, according to such an embodiment of the present disclosure, said under structure portions 12 of said vehicle body provides at least parts of a space provision arrangement configured to provide said space S1 in connection to the upper side 4a of the track 4 of the respective track assembly, so as to facilitate retention of the gaseous medium G introduced by means of said gas provision device 100 and thereby the reduction of the amount of water within said space. The gas provision device 100 applied to such a tracked vehicle lacking such an enclosure configuration device 20 but having a vehicle body with such under-structure portions 12 may be a gas provision device as described with reference to any of FIGS. 2, 3, 4, 5A-5B and 6A-6B. Such a tracked vehicle may comprise a drive means for driving said endless track, where said drive means comprises a combustion engine, wherein said gas provision device 100 is configured to utilize exhaust gas from said combustion engine for said introduction of gaseous medium into said flow of water at said upper side 4a of said endless track 4, facilitating efficient swimming operation. The arrangement for facilitating amphibious operation of such a tracked vehicle may comprise a gas provision device 100 which is configured to control said introduction of gaseous medium G into the flow of water at the upper side 4a of said endless track 4 based on rotational speed of said endless track 4.

According to an aspect of the present disclosure, said gas provision device 100 is configured to control said introduction of gaseous medium into the flow of water at the upper side 4a of said endless track 4. According to an aspect of the present disclosure, said gas provision device 100 is configured to control said introduction of gaseous medium into the flow of water at the upper side 4a of said endless track 4 based on rotational speed of said endless track 4.

According to an aspect of the present disclosure, said arrangement A for facilitating amphibious operation of a tracked vehicle comprises a control device 200 for controlling introduction of gaseous medium into the flow of water at the upper side 4a of said endless track 4. According to an aspect of the present disclosure, said control device 200 is comprised in said gas provision device 100. According to an aspect of the present disclosure, said control device 200 is operably connected to said gas provision device 100.

The control device 200 may be configured to control introduction of gaseous medium into the flow of water at the upper side 4a of said endless track 4 in connection to an amphibious operation based on one or more of position of the tracked vehicle V1, level of water surrounding the vehicle, amphibious operation activation by operator and speed of the respective endless track 4 of the vehicle.

The control device 200 may be configured to control pressure of introduced gaseous medium into the flow of water at the upper side 4a of said endless track 4 in connection to an amphibious operation based on one or more of position of the tracked vehicle V1, level of water surrounding the vehicle, amphibious operation activation by operator and speed of the respective endless track 4 of the vehicle.

The control device 200 may be configured to control type of gaseous medium introduced into the flow of water at the upper side 4a of said endless track 4, said type of gaseous medium being e.g. external air external to the vehicle, air within said vehicle, exhaust gas of combustion engine of drive means of vehicle, in connection to an amphibious operation based on one or more of position of the tracked vehicle V1, level of water surrounding the vehicle, amphibious operation activation by operator and speed of the respective endless track 4 of the vehicle, accessibility to different types of gaseous medium.

According to an aspect of the present disclosure, said control device 200 is configured to control said introduction of gaseous medium G into the flow of water at the upper side 4a of said endless track 4 based on rotational speed of said endless track 4. According to an aspect of the present disclosure, said control device 200 is configured to control said introduction of gaseous medium G into the flow of water at the upper side 4a of said endless track based on rotational speed of said endless track 4 such that a higher amount of gaseous medium is introduced into said flow of water at a higher rotational speed than at a lower rotational speed, relatively lower than said higher rotational speed.

According to an aspect of the present disclosure, said control, by means of said control device, of said introduction of gaseous medium G into the flow of water at the upper side 4a of said endless track 4 based on rotational speed of said endless track 4, comprises control based on direction of rotational speed of said endless track 4. According to an aspect of the present disclosure, said control device 200 is configured to control said introduction of gaseous medium into the flow of water at the upper side 4a of said endless track 4 based on direction of rotational speed of said endless track 4. According to an aspect of the present disclosure, said control device 200 is configured to control said introduction of gaseous medium into the flow of water at the upper side 4a of said endless track 4 based on rotational direction of said endless track 4.

According to an aspect of the present disclosure, said control device 200 is configured to control said introduction of gaseous medium into the flow of water at the upper side 4a of said endless track 4 based on direction of rotational speed, i.e. rotational direction, of said endless track 4 such that said introduction of gaseous medium G into the flow of water is provided from the rear side of the tracked vehicle V1 during a rotation of said endless track 4 for forward drive of the tracked vehicle V1, and such that said introduction of gaseous medium into the flow of water is provided from the front side of the tracked vehicle V1 during a rotation of said endless track for rearward drive of the tracked vehicle V1.

According to an aspect of the present disclosure, said control device 200 may be configured to control said gas valve arrangement 130 for controlling introduction of gaseous medium G into the flow of water at the upper side 4a of the track 4.

The position of the vehicle V1 may be determined by means of any suitable detector unit, now shown, for detecting vehicle position. The position of the vehicle may be determined by means a Global Navigation Satellite System, GNSS, e.g. a global positioning system, GPS, for determining the position of the vehicle and thus whether the tracked vehicle V1 is driving on land and thus is performing a land operation or whether the tracked vehicle V1 is in connection to perform an amphibious operation. The position of the tracked vehicle may be determined by means of one or more sensor units arranged on the tracked vehicle, such as one or more cameras and/or one or more laser scanners. Thus, the detector unit for detecting vehicle position may comprise a Global Navigation satellite System and/or one or more sensor units such as cameras.

The control device 200 may according to an aspect of the present disclosure comprise or be operably connected to the detector unit for detecting vehicle position so as to determine whether the vehicle is in connection to perform an amphibious operation.

The level of water surrounding the tracked vehicle V1 may be determined by means of any suitable water level sensor device, not shown, arranged in connection to the vehicle. The control device 200 may according to an aspect of the present disclosure comprise or be operably connected to the water level sensor device. The control device 200 may according to an aspect of the present disclosure be configured to activate introduction of gaseous medium into the flow of water at the upper side 4a of the track 4 of the respective track assembly.

The amphibious operation activation by operator may comprise any suitable operator activatable activation member, not shown. Such an activation member may be any suitable activation member such as a switch, touch screen, lever or the like. The control device 200 may according to an aspect of the present disclosure comprise or be operably connected to the operator activatable activation member for activating introduction of gaseous medium into the flow of water at the upper side 4a of the track 4 of the respective track assembly by means of said gas provision device 100. The gas provision device 100 may according to an aspect of the present disclosure comprise or be operably connected to the operator activatable activation member for activation of introduction of gaseous medium into the flow of water at the upper side 4a of the track 4 of the respective track assembly.

FIG. 4 schematically illustrates a side view of an articulated tracked vehicle V2 during an amphibious operation according to an embodiment of the present disclosure.

Thus, the amphibious tracked vehicle according to an aspect of the present disclosure may be a stand alone tracked vehicle V1 as shown in FIG. 2 and FIG. 3 or an articulated tracked vehicle V2 as illustrated in FIG. 4.

The articulated tracked vehicle V2 comprises a first tracked vehicle unit V1 and a second tracked vehicle unit VIA pivotably connected to the first vehicle unit V1 via an articulation joint Y. The first vehicle unit V1 is configured to be the leading vehicle and the second vehicle unit VIA the trailing vehicle. The first vehicle unit V1, according to an aspect of the present disclosure, essentially corresponds to the amphibious tracked vehicle illustrated in FIG. 2 and FIG. 3 and therefore has the same reference sign V1.

Thus, the first vehicle unit V1 comprises a track assembly pair comprising opposite track assemblies for driving the vehicle unit V1, a left track assembly T1 shown in FIG. 4, and a right track assembly.

The first vehicle unit V1 comprises a vehicle body 10. The track assembly pair is suspendedly connected to the vehicle body 10.

The respective track assembly, in FIG. 4 illustrated with the left track assembly T1, comprises two end wheels 1, 2 in the form of a front wheel 1 and a rear wheel 2, and further a plurality of road wheels 3 there between. The front wheel 1 is according to the present disclosure a drive wheel 1 and the rear wheel 2 is according to the present disclosure a tension wheel 2. The respective track assembly, in FIG. 4 illustrated with the left track assembly T1, further comprises a plurality of road wheels 3.

The respective track assembly, in FIG. 4 illustrated with the left track assembly T1, further comprises an endless track 4. Said endless track 4 is configured to be disposed around said end wheels 1, 2 and plurality of road wheels 3. The endless track 4 is thus configured to run around the drive wheel 1, tension wheel 2 and plurality of road wheels 3. Each track assembly thus comprises an endless track 4 arranged to run over a set of wheels of the track assembly T1.

The endless track 4 is a propulsion track 4 running around said wheels 1, 2, 3 for driving the vehicle unit V1. The endless track 4 has an outer side with an outer surface which, during swimming operation, will be in contact with water and move the water when the endless track is running around the wheels 1, 2, 3. When the endless track is running around the wheels 1, 2, 3 a portion of the outer side will be faced upwardly and thus be an upper side 4a and an opposite portion of the outer side will face downwardly and thus be an underside 4b.

The drive wheel 1 is configured to be operated by any suitable drive means such as an internal combustion engine and or/or an electric motor. The drive wheel 1 is configured to be rotated by the drive means for rotating the endless track for driving the vehicle V1.

The vehicle body 10 comprises under structure portions 12, a left under structure portion 12 shown in FIG. 4 and an opposite right under structure portion, configured to run over an upper side 4a of a track 4 of a track assembly at a distance from the upper side 4a of the track 4, providing a space S1, the space S1 in connection to the left track assembly TIA being shown in FIG. 4.

Further, the second vehicle unit VIA, pivotably connected to the first vehicle unit V1, comprises a track assembly pair comprising opposite track assemblies for the vehicle unit VIA, a left track assembly TIA shown in FIG. 4, and a right track assembly.

The second vehicle unit VIA comprises a vehicle body 10A. The track assembly pair is suspendedly connected to the vehicle body 10A.

The respective track assembly, in FIG. 4 illustrated with the left track assembly TIA, comprises two end wheels 1A, 2A in the form of a front wheel 1A and a rear wheel 2A, and further a plurality of road wheels 3A there between. The front wheel 1A is according to the present disclosure a drive wheel 1A and the rear wheel 2A is according to the present disclosure a tension wheel 2A. The respective track assembly, in FIG. 4 illustrated with the left track assembly TIA, further comprises a plurality of road wheels 3A.

The respective track assembly, in FIG. 4 illustrated with the left track assembly TIA, further comprises an endless track 4A. Said endless track 4A is configured to be disposed around said end wheels 1A, 2A and plurality of road wheels 3A. The endless track 4A is thus configured to run around the drive wheel 1A, tension wheel 2A and plurality of road wheels 3A. Each track assembly thus comprises an endless track 4A arranged to run over a set of wheels of the track assembly TIA.

The endless track 4A is a propulsion track 4A running around said wheels 1A, 2A, 3A for driving the vehicle unit V1. The endless track 4A has an outer side with an outer surface which, during swimming operation, will be in contact with water and move the water when the endless track is running around the wheels 1A, 2A, 3A. When the endless track is running around the wheels 1A, 2A, 3A a portion of the outer side will be faced upwardly and thus be an upper side 4a and an opposite portion of the outer side will face downwardly and thus be an underside 4b.

The drive wheel 1A is configured to be operated by any suitable drive means, not shown in FIG. 4, such as an internal combustion engine and or/or an electric motor. The drive wheel 1A is configured to be rotated by the drive means for rotating the endless track for driving the second vehicle unit V1A. The drive wheel 1A is according to an aspect configured to be operated by a drive means arranged in the first vehicle unit V1, wherein drive force provided by the drive means is transferred to the drive wheel 1A of the second vehicle unit V1A via any suitable powertrain.

The vehicle body 10A comprises under structure portions 12A, a left under structure portion 12A shown in FIG. 4 and an opposite right under structure portion, configured to run over an upper side 4a of a track 4 of a track assembly at a distance from the upper side 4a of the track 4A, providing a space, the space S1A in connection to the left track assembly T1A being shown in FIG. 4.

The articulated tracked vehicle V2 comprises an arrangement A for facilitating swimming operation of the articulated tracked vehicle V2.

The amphibious articulated tracked vehicle V2 comprises an arrangement A for facilitating swimming operation of the tracked vehicle.

The arrangement A comprises a gas provision device 100, 100A configured to, in connection to swimming operation, introduce a gaseous medium G into the flow of water at the upper side 4a of the track 4, 4A of the respective track assembly T1, T1A of the respective vehicle unit V1, V1A of the articulated vehicle V2 so as to reduce the amount of water in connection to said upper side 4a.

According to an aspect of the present disclosure, said provision device 100, 100A is configured to introduce a gaseous G medium into the flow of water at the upper side 4a of the track of the respective track assembly so as to reduce the amount of water in connection to said upper side 4a so that a propulsion reducing force associated with said flow of water at said upper side 4a is reduced.

Said gas provision device 100, 100A is configured to provide pressurized introduction of said gaseous medium G such that pressurized gaseous medium G is introduced into said flow of water in connection to a space S1, S1A over said upper side 4a so that water in said space is reduced such that the density of the mass associated with said flow of water providing said propulsion reducing force is reduced.

In the example illustrated in FIG. 4, said gas provision device 100, 100A comprises a first gas provision device 100 arranged in connection to the first vehicle unit V1 and a second gas provision device 100A arranged in connection to the second vehicle unit V1A of said articulated tracked vehicle V2. According to an alternative aspect of the present disclosure, said gas provision device 100, 100A may be one single gas provision device arranged in one of the vehicle units V1, V1A of the articulated vehicle V2, wherein said single gas provision device is configured to transfer gaseous medium from one of the vehicle units to the other vehicle unit.

According to an aspect of the present disclosure, said arrangement A comprises a space provision arrangement 12, 20, 12A, 20A configured to provide said space S1, S1A in connection to the upper side 4a of the track 4 of the respective track assembly T1, T1A of the respective vehicle unit V1, V1A of said articulated vehicle V2. Said space provision arrangement 12, 20, 12A, 20A is configured to be arranged so as to facilitate retention of the gaseous medium G introduced by means of said gas provision device 100 and thereby the reduction of the amount of water within said space S1, S1A.

Said space provision arrangement 12, 20, 12A, 20A comprises a first space provision arrangement 12, 20 configured to provide said space S1 in connection to the upper side 4a of the track 4 of the respective track assembly T1 of the leading vehicle unit V1 of said articulated vehicle V2. Said space provision arrangement 12, 20, 12A, 20A comprises a first space provision arrangement 12A, 20A configured to provide said space S1A in connection to the upper side 4a of the track 4A of the respective track assembly T1A of the trailing vehicle unit V1A of said articulated vehicle V2.

According to an aspect of the present disclosure, said space provision arrangement 12, 20, 12A, 20A comprises said under structure portions 12, 12A of said vehicle body 10, 10A of the respective vehicle unit V1, V1A. Each under structure portion 12, 12A is arranged to run over an upper side 4a of a track 4 of a track assembly T1, T1A at a distance from the upper side 4a of the track 4, 4A so that said space S1, S1A is provided between each under structure portion 12, 12A and the upper side 4a of the track 4 of the corresponding track assembly T1, T2.

According to an aspect of the present disclosure, said space provision arrangement 12, 20, 12A, 20A comprises an enclosure configuration 20, 20A arranged in connection to said vehicle body 10, 10A so as to at least partly provide enclosure of said space S1, S1A. According to an aspect of the present disclosure, said enclosure configuration 20, 20A comprises a first enclosure configuration 20 arranged in connection to said vehicle body 10 of the leading vehicle unit 10 so as to at least partly provide enclosure of said space S1, and a second enclosure configuration 20A arranged in connection to said vehicle body 10B of said trailing vehicle unit V1A, so as to at least partly provide enclosure of said space S1A.

According to an aspect of the present disclosure, said enclosure configuration 20, 20A may be an enclosure configuration essentially corresponding to the enclosure configuration described with reference to FIG. 2.

According to an aspect of the present disclosure, said enclosure configuration 20, 20A may comprise elongated side elements arranged at and configured to run along a respective side of the respective vehicle unit so as to provide enclosure of said space S1, S1A for further facilitating retention of gaseous medium G introduced into said space S1. Said elongated side elements may be arranged in connection to, e.g. connected to, said vehicle body 10, 10A, or be integrated portions of said vehicle body 10, 10A. According to an aspect of the present disclosure, said enclosure configuration 20, 20A may comprise front elements arranged at a front portion of the respective vehicle unit and/or rear elements arranged at a rear portion of the respective vehicle unit so as to provide further enclosure of said space S1, S1A for further facilitating retention of gaseous medium introduced into said space. Said front elements and/or rear elements may be arranged in connection to, e.g. connected to, said vehicle body 10, 10A, or be integrated portions of said vehicle body 10, 10A.

The gas provision device 100 according to the present disclosure, e.g. the gas provision device 100 schematically illustrated in FIGS. 2 and 3 and/or the gas provision device 100, 100A schematically illustrated in FIG. 4 may comprise any suitable gas provision device having any suitable function for providing gaseous medium into said space S1, S1A.

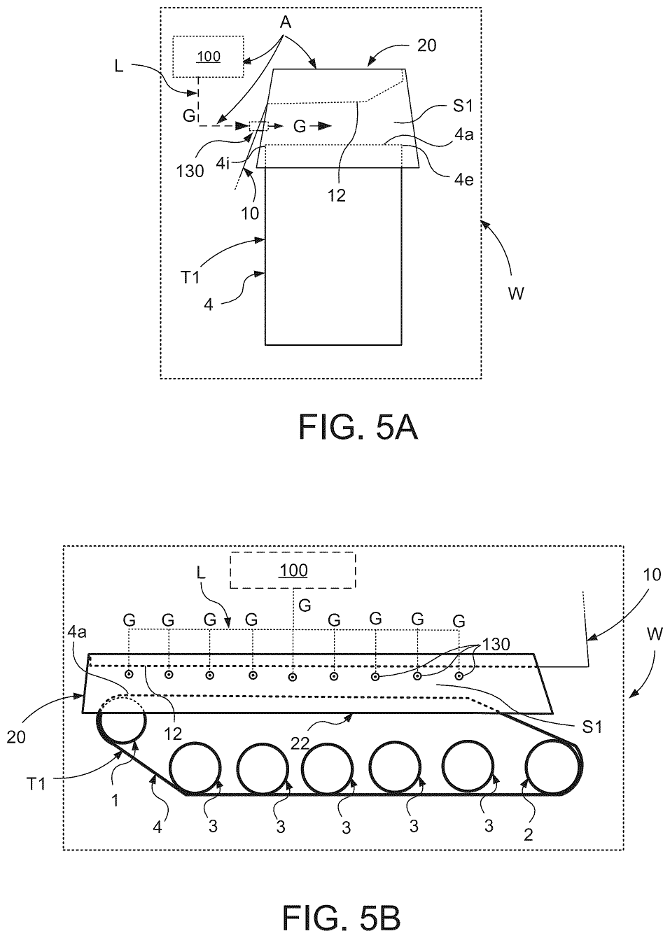

FIG. 5A schematically illustrates a front view of a portion of a tracked vehicle during an amphibious operation, said tracked vehicle being provided with an arrangement A for facilitating amphibious operation of the vehicle, according to an embodiment of the present disclosure. FIG. 5B schematically illustrates a side view of a portion of a tracked vehicle during an amphibious operation, said tracked vehicle being provided with an arrangement A for facilitating amphibious operation of the vehicle, according to an embodiment of the present disclosure. The tracked vehicle from which portions are illustrated in FIGS. 5A-5B may be essentially the same tracked vehicle V1 or at least a vehicle having essentially the same configuration as illustrated in e.g. FIGS. 2-3.

According to an aspect of the present disclosure, schematically illustrated in FIGS. 5A-5B, said gas provision device 100 is configured to provide introduction of gaseous medium G into the flow of water at the upper side 4a of said endless track 4 at said internal side portion 4i of said track 4 of the respective track assembly in connection to said upper side 4a.

According to an aspect of the present disclosure, schematically illustrated in FIGS. 5A-5B, said arrangement A comprises a space provision arrangement 12, 20 configured to provide said space S1, e.g. as disclosed in FIGS. 2-3, wherein said gas provision device 100 is configured to provide introduction of gaseous medium G into the space S1 provided by said space provision arrangement 12, 20 with said flow of water at the upper side 4a of said endless track 4 at said internal side portion 4i of said track 4 of the respective track assembly in connection to said upper side 4a.

According to an aspect of the present disclosure, said introduction of gaseous medium at said internal side portion 4i being directed in the transversal direction relative to the longitudinal extension of the vehicle in a direction away from the outer side of the vehicle V1.

According to an aspect of the present disclosure, schematically illustrated in FIGS. 5A-5B, said arrangement A comprises a gas valve arrangement 130, e.g. as described with reference to FIGS. 2-3, wherein said gas provision device 100 is configured to provide introduction of gaseous medium into the space S1 at the upper side 4a of said endless track 4 at said internal side portion 4i in connection to said upper side 4a via said gas valve arrangement 130.

According to an aspect of the present disclosure, schematically illustrated in FIG. 5B, said gas provision device 100 is configured to provide introduction of gaseous medium into the space S1 at the upper side 4a of said endless track 4 at said internal side portion 4i in connection to said upper side 4a via a set of valve members of said gas valve arrangement 130, said valve members being arranged in connection to said internal side portion 4i, between the under structure portion 12 and the upper side 4a and being distributed along the respective side of the vehicle.

According to an aspect, said valve members of said gas valve arrangement 130 are distributed along the longitudinal extension of said vehicle, in connection to said internal side portion 4i, from a rear portion to a front portion of the vehicle.

According to an aspect of the present disclosure, said gas provision device 100 is configured to control said introduction of gaseous medium G into the flow of water at the upper side 4a of said endless track 4 based on rotational speed of said endless track 4 such that a higher amount of gaseous medium G is introduced into said flow of water via said distributed valve members of said gas valve arrangement 130 at a higher rotational speed than at a lower rotational speed, relatively lower than said higher rotational speed.

According to an aspect of the present disclosure, said gas provision device 100 is configured to control said introduction of gaseous medium into the flow of water at the upper side 4a of said endless track 4 based on direction of rotational speed, i.e. rotational direction, of said endless track 4 such that at least a greater portion of said introduced gaseous medium G into the flow of water is provided from valve members of said set of valve member of said valve arrangement 130 being arranged closer to the rear side of the tracked vehicle during a rotation of said endless track 4 for forward drive of the tracked vehicle, and such that at least a greater portion of said introduced gaseous medium G into the flow of water is provided from valve members of said set of valve member of said valve arrangement 130 being arranged closer to the front side of the tracked vehicle during a rotation of said endless track for rearward drive of the tracked vehicle.

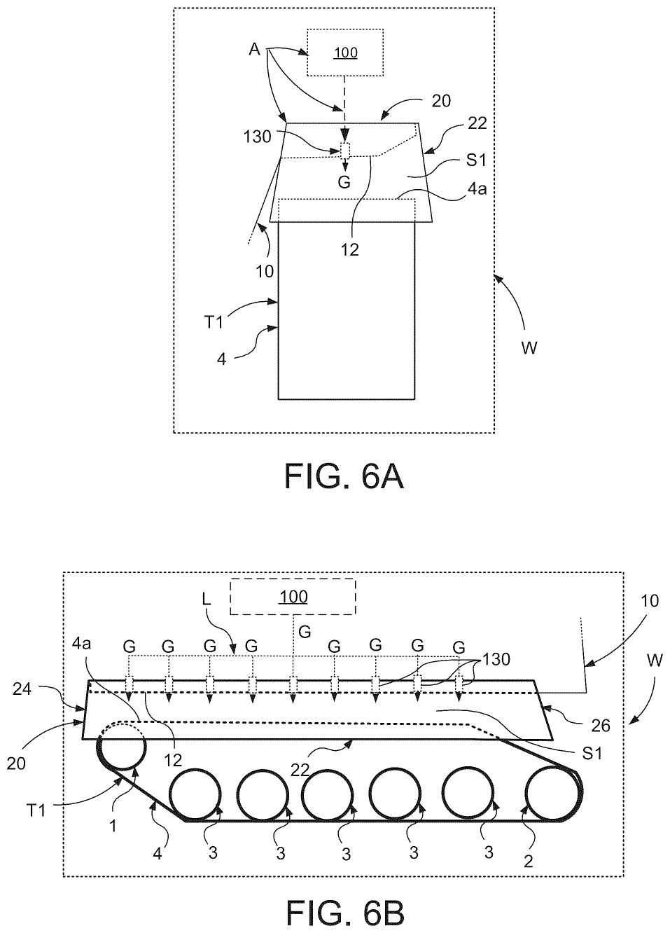

FIG. 6A schematically illustrates a front view of a portion of a tracked vehicle during an amphibious operation, said tracked vehicle being provided with an arrangement A for facilitating amphibious operation of the vehicle, according to an embodiment of the present disclosure. FIG. 6B schematically illustrates a side view of a portion of a tracked vehicle during an amphibious operation, said tracked vehicle being provided with an arrangement A for facilitating amphibious operation of the vehicle, according to an embodiment of the present disclosure. The tracked vehicle from which portions are illustrated in FIGS. 6A-6B may be essentially the same tracked vehicle V1 or at least a vehicle having essentially the same configuration as illustrated in e.g. FIGS. 2-3.

According to an aspect of the present disclosure, schematically illustrated in FIGS. 6A-6B, said arrangement A comprises a space provision arrangement 12, 20 with under structure portion 12, said space provision arrangement 12, 20 being configured to provide said space S1, e.g. as disclosed in FIGS. 2-3, wherein said gas provision device 100 is configured to provide introduction of gaseous medium G into the flow of water at the upper side 4a of said endless track 4 in connection to said under structure portion 12 of said vehicle body 10.

According to an aspect of the present disclosure, said introduction of gaseous medium in connection to said under structure portion 12 is directed in a direction essentially orthogonal to the transversal extension and longitudinal extension of the vehicle in a direction from the under structure portion 12 downwardly towards said upper portion 4a of said track of the respective track assembly of the tracked vehicle V1.

According to an aspect of the present disclosure, schematically illustrated in FIGS. 6A-6B, said arrangement A comprises a gas valve arrangement 130, e.g. as described with reference to FIGS. 2-3, wherein said gas provision device 100 is configured to provide introduction of gaseous medium into the space S1 at the upper side 4a of said endless track 4 in connection to said under structure portion 12 via said gas valve arrangement 130.

According to an aspect of the present disclosure, schematically illustrated in FIG. 6B, said gas provision device 100 is configured to provide introduction of gaseous medium into the space S1 at the upper side 4a of said endless track 4 in connection to said under structure portion 12 via a set of valve members of said gas valve arrangement 130, said valve members being arranged in connection to said under structure portion 12, and being distributed along the longitudinal extension of the under structure portion 12 at the respective side of the vehicle.

According to an aspect of the present disclosure, said valve members are arranged in connection to said under structure portion 12, and being distributed along the longitudinal extension of the under structure portion 12 at the respective side of the vehicle.

According to an aspect of the present disclosure, said gas provision device 100 is configured to control said introduction of gaseous medium G into the flow of water at the upper side 4a of said endless track 4 based on rotational speed of said endless track 4 such that a higher amount of gaseous medium G is introduced into said flow of water via said distributed valve members of said gas valve arrangement 130 at a higher rotational speed than at a lower rotational speed, relatively lower than said higher rotational speed.

According to an aspect of the present disclosure, said gas provision device 100 is configured to control said introduction of gaseous medium into the flow of water at the upper side 4a of said endless track 4 based on direction of rotational speed, i.e. rotational direction, of said endless track 4 such that at least a greater portion of said introduced gaseous medium G into the flow of water is provided from valve members of said set of valve member of said valve arrangement 130 being arranged closer to the rear side of the tracked vehicle during a rotation of said endless track 4 for forward drive of the tracked vehicle, and such that at least a greater portion of said introduced gaseous medium G into the flow of water is provided from valve members of said set of valve member of said valve arrangement 130 being arranged closer to the front side of the tracked vehicle during a rotation of said endless track for rearward drive of the tracked vehicle.

The foregoing description of the preferred embodiments of the invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling other skilled in the art to understand the invention for various embodiments and with the various modifications as are suited to the particular use contemplated.

1. An arrangement for facilitating amphibious operation of a tracked vehicle, said tracked vehicle comprising one or more vehicle bodies and at least one track assembly pair per vehicle body, said track assembly pair being connected to the vehicle body, the track assembly pair comprising two track assemblies for driving the vehicle, each track assembly comprising a drive means driven endless track arranged to run over a set of wheels of the track assembly and, in connection to amphibious operation, being configured to operate under the water surface by rotating in the water providing a flow of water so as to provide a swimming operation of the vehicle, characterized in that said arrangement comprises a gas provision device configured to, in connection to swimming operation, introduce a gaseous medium into the flow of water at the upper side of the track of the respective track assembly so as to reduce the amount of water in connection to said upper side.

2. The arrangement of claim 1, wherein said gas provision device is configured to provide pressurized introduction of said gaseous medium such that pressurized gaseous medium is introduced into said flow of water in connection to a space over said upper side so that water in said space is reduced such that the density of the mass associated with said flow of water providing a propulsion reducing force associated with said flow of water at said upper side is reduced.

3. The arrangement of claim 1, wherein said drive means configured to drive said endless track comprises a combustion engine, wherein said gas provision device is configured to utilize exhaust gas from said combustion engine for said introduction of gaseous medium into said flow of water at said upper side of said endless track.

4. The arrangement of claim 1, wherein said gas provision device comprises a pump device and/or a compressor device configured to provide said introduction of gaseous medium into said flow of water at said upper side of said endless track.

5. The arrangement of claim 1, wherein said gaseous medium comprises air, wherein said gas provision device is configured to retain air stored within said vehicle and/or externally from an outer side portion of said vehicle configured to be above water during swimming operation of said vehicle.

6. The arrangement of claim 1, wherein said gas provision device is configured to control said introduction of gaseous medium into the flow of water at the upper side of said endless track based on rotational speed of said endless track.

7. The arrangement of claim 1, wherein said gas provision device is configured to provide introduction of gaseous medium into the flow of water at the upper side of said endless track via one or more introduction openings in connection to said upper side.

8. The arrangement of claim 1, wherein said gas provision device is configured to provide introduction of gaseous medium into the flow of water at the upper side of said endless track from the rear side of the vehicle in connection to said upper side, said introduction of gaseous medium from said rear side being directed in the direction of the flow of water.

9. The arrangement of claim 1, further comprising a space provision arrangement configured to provide a space in connection to the upper side of the track of the respective track assembly, so as to facilitate retention of the gaseous medium introduced by means of said gas provision device and thereby the reduction of the amount of water within said space.

10. The arrangement of claim 9, wherein said space provision arrangement comprises under structure portions of said vehicle body, each under structure portion being arranged to run over an upper side of a track of a track assembly at a distance from the upper side of the track so that said space is provided between each under structure portion and the upper side of the track of the corresponding track assembly.

11. The arrangement of claim 10, wherein said space provision arrangement comprises an enclosure configuration arranged so as to at least partly provide enclosure of said space.

12. The arrangement of claim 11, wherein said enclosure configuration comprises elongated side elements arranged at and configured to run along a respective side of the vehicle so as to provide enclosure of said space for further facilitating retention of gaseous medium introduced into said space.

13. The arrangement of claim 12, wherein said enclosure configuration comprises front elements arranged at a front portion of the vehicle and/or rear elements arranged at a rear portion of the vehicle so as to provide further enclosure of said space for further facilitating retention of gaseous medium introduced into said space.

14. A tracked vehicle comprising an arrangement of claim 1.

15. A tracked vehicle of claim 14, wherein said tracked vehicle is an articulated tracked vehicle comprising a first vehicle unit and a second vehicle unit pivotably connected to the first vehicle unit via an articulation joint, each of said vehicle units comprising a vehicle body and track assembly pair suspendedly connected to respective vehicle body.
